(19) United States
(12) Patent Application Publication
(10) Pub. No.: US 2026/0253276 A1
(43) Pub. Date: Aug. 27, 2026

(54) VECTORIZING RASTER IMAGES WHILE PRESERVING TRANSPARENCY AND TRANSLUCENCY ATTRIBUTES

(71) Applicant: Adobe Inc., San Jose, CA (US)

(72) Inventors: Ankur Krishna Gautam, Noida (IN); Anshuma Shukla, Noida (IN); Vivek Agrawal, Noida (IN)

(21) Appl. No.: 19/064,076

(22) Filed: Feb. 26, 2025

(51) Int. Cl. G06T 11/40; G06T 7/11

(52) U.S. Cl. CPC G06T 11/40; G06T 7/11; G06T 2207/10024; G06T 2210/62

(57) ABSTRACT

The present disclosure relates to systems, methods, and non-transitory computer-readable media that vectorize raster images while translating transmissive properties portrayed therein. For instance, one or more embodiments involve receiving a raster image that includes a set of pixels having a transmissive property and extracting a plurality of segments from the raster image using a segmentation model. Some embodiments further involve generating, from the raster image, a segment-to-pixel mapping that maps a segment from the plurality of segments to the set of pixels having the transmissive property. Using the segment-to-pixel mapping, some embodiments vectorize the raster image by generating a vector graphic having a vector path that corresponds to the segment and includes the transmissive property. Some implementations further provide the vector graphic for display.

### BACKGROUND

Recent years have seen significant advancement in hardware and software platforms for creating vector art. Indeed, as the use of vector art has become increasingly ubiquitous, systems have developed to facilitate the creation of such vector art. To illustrate, some systems offer tools that enable the creation of vector graphics from corresponding source raster images. Despite these advancements, conventional vector graphics systems often fail to flexibly create a vector graphic that preserves the transparency and/or translucency attributes of its source raster image, leading to results that inaccurately portray the intended visual effects.

### SUMMARY

One or more embodiments described herein provide benefits and/or solve one or more of the foregoing or other problems in the art with systems, methods, and non-transitory computer-readable media that use opacity-based color blending to flexibly translate transparency and/or translucency attributes when creating vector graphics from raster images. To illustrate, in one or more embodiments, the disclosed systems modify a raster image by blending its transparent and/or translucent pixels with one or more selected color values. The disclosed systems perform segmentation on the modified raster image and map the resulting segments to the opacity and color values of the original pixels. The disclosed systems further generate vector paths that correspond to the segments and include color and opacity attributes that reflect those values from the mappings. In this manner, the system implements a flexible approach to vectorization that is agnostic to the underlying segmentation engine.

Additional features and advantages of one or more embodiments of the present disclosure are outlined in the following description.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates an example environment in which an opacity-aware vectorization system operates in accordance with one or more embodiments;

FIG. 2 illustrates the opacity-aware vectorization system vectorizing a raster image while translating a transmissive property therein in accordance with one or more embodiments;

FIG. 3 illustrates the opacity-aware vectorization system modifying pixels of a raster image having a transmissive property in accordance with one or more embodiments;

FIG. 4 illustrates, the opacity-aware vectorization system extracting segments from a raster image in accordance with one or more embodiments;

FIG. 5 illustrates the opacity-aware vectorization system generating a segment-to-pixel mapping for a raster image in accordance with one or more embodiments;

FIG. 6 illustrates, the opacity-aware vectorization system generating a vector graphic from a raster image in accordance with one or more embodiments;

FIG. 7 illustrates the opacity-aware vectorization system vectorizing a raster image based on a user defined setting in accordance with one or more embodiments;

FIG. 8 illustrates an example schematic diagram of an opacity-aware vectorization system in accordance with one or more embodiments;

FIG. 9 illustrates a flowchart of a series of acts for vectorizing a raster image while translating a transmissive property therein in accordance with one or more embodiments; and

FIG. 10 illustrates a block diagram of an exemplary computing device in accordance with one or more embodiments.

### DETAILED DESCRIPTION

One or more embodiments described herein include an opacity-aware vectorization system that flexibly translates the transparency and/or translucency attributes when performing vectorization on raster images. To illustrate, in one or more embodiments, the opacity-aware vectorization system blends the transparent and/or translucent regions of a raster image with color to facilitate the treatment of these regions as opaque during segmentation. The opacity-aware vectorization system also generates a segment-to-pixel mapping that maps the segmentation results to pixels of the raster image. Further, the opacity-aware vectorization system maps the opacity and color values of those pixels to each segment. Using these mappings, the opacity-aware vectorization system vectorizes the raster image by generating, for each segment, one or more vector paths that include opacity and color reflective of those values of the corresponding pixels.

To illustrate, in one or more embodiments, the opacity-aware vectorization system receives a raster image that includes a set of pixels having a transmissive property and extracts a plurality of segments using a segmentation model. Additionally, the opacity-aware vectorization system generates, from the raster image, a segment-to-pixel mapping that maps a segment from the plurality of segments to the set of pixels having the transmissive property. Using the segment-to-pixel mapping, the opacity-aware vectorization system vectorizes the raster image by generating a vector graphic having a vector path that corresponds to the segment and includes the transmissive property. In some cases, the opacity-aware vectorization system further provides the vector graphic for display, such as by providing the vector graphic for display on the client device from which the raster image was received.

As just mentioned, in one or more embodiments, the opacity-aware vectorization system vectorizes a raster image while translating its transparency and/or translucency attributes. In particular, in some cases, the opacity-aware vectorization system generates, from the raster image, a vector graphic that includes vector opacity values corresponding to the opacity values of the raster image and/or vector color values corresponding to the color values of the raster image. In some cases, the opacity-aware vectorization system performs the vectorization via a vectorization pipeline that involves generating and implementing a segment-to-pixel mapping that maps segments extracted from the raster image to pixels included therein.

To illustrate, in one or more embodiments, the opacity-aware vectorization system modifies pixels of a raster image having a transmissive property (e.g., pixels having a transparency or a translucency). For instance, in some cases, the opacity-aware vectorization system blends the pixels with a color value, such as by blending transparent pixels with a determined distant color value and/or blending translucent pixels with an additional color value (e.g., a white color value). The opacity-aware vectorization system uses a segmentation model to extract one or more segments from the raster image having the modified pixels.

Additionally, in some embodiments, the opacity-aware vectorization system generates a segment-to-pixel mapping that maps each segment extracted via the segmentation model to the pixels from the raster image. In some cases, the opacity-aware vectorization system uses this mapping to generate one or more additional maps. For example, in certain cases, the opacity-aware vectorization system generates an opacity map that maps opacity values represented in a segment to the pixels of that segment and/or generates a color map that maps color values represented in a segment to the pixels of that segment.

Further, in one or more embodiments, the opacity-aware vectorization system uses the mapping information to generate a vector graphic from the raster image. For instance, in some cases, the opacity-aware vectorization system uses the opacity map to determine a vector opacity value for each vector path generated for the vector graph and/or uses the color map to determine a vector color value for each vector path. Thus, in certain embodiments, the opacity-aware vectorization system generates a vector graphic having vector paths that correspond to the segments of the raster image, vector opacity values corresponding to the opacity values of the raster image, and vector color values corresponding to the color values of the raster image.

As mentioned above, conventional vector graphics systems suffer from several technological shortcomings that result in inflexible and inaccurate operation. For instance, many conventional systems are inflexible in that they fail to flexibly vectorize raster images while preserving their transparency and/or translucency attributes. To illustrate, conventional systems often perform segmentation-based vectorization by generating vector paths that correspond segments extracted from raster images via a segmentation model. Segmentation models, however, typically focus on color differences and lack support for the alpha channel of an image—the channel storing the image's opacity information. As such, these systems tend to lose data related to the transparency and/or translucency represented in a raster image during vectorization. Some systems attempt to address the transparency issue by filling transparent regions with white. Additionally, some systems attempt to address the translucency issue by dropping translucency altogether, modifying translucent regions to appear either completely opaque or completely transparent based on their opacity level. While such systems attempt to address the issues with segmentation, these solutions often still fail to produce vector graphics that maintain the transparency and/or translucency attributes of the corresponding raster images.

Additionally, conventional vector graphics systems fail to operate accurately. In particular, conventional systems often fail to generate vector graphics that accurately capture the visual elements of the corresponding raster images, specifically with regard to transparency and/or translucency. Indeed, as segmentation models typically lack alpha channel support, the resulting vector graphics produced by these systems often omit the transparency and/or translucency of the corresponding raster images. While some systems attempt to address these issues, they often fail to do so properly and even introduce new problems in some cases. For instance, systems that fill transparent regions with white tend to create unintended additional transparent regions, lose white colored regions, create artifacts along the boundaries of translucent pixels, or create unintended hollow regions in designs with a radial gradient. Systems that drop translucency altogether produce vector results void of translucent elements. Thus, the resulting vector graphics typically fail to provide the same visual quality and artistic intent of the original image.

One or more embodiments of the opacity-aware vectorization system provide several advantages over conventional systems. For example, one or more embodiments of the opacity-aware vectorization system improve the flexibility of implementing computing devices when compared to conventional systems. In particular, by implementing its vectorization pipeline, the opacity-aware vectorization system flexibly preserves the transparency and/or translucency of a raster image during vectorization. For instance, by blending transparent pixels with a distant color value and/or blending translucent pixels with an additional color value (e.g., a white color value), the opacity-aware vectorization system enables a raster image to be properly segmented. Indeed, the opacity-aware vectorization system prepares the raster image such that all its regions are viewed as opaque from the perspective of the segmentation model, enabling the segmentation model to properly extract all regions. Further, this enables vectorization to be agnostic of the underlying segmentation model. By mapping the opacity values of a raster image to its extracted segments, the opacity-aware vectorization system maintains those values for translation of the transparency and/or translucency to the final vector graphic.

Additionally, one or more embodiments of the opacity-aware vectorization system improve the accuracy of implementing computing devices when compared to conventional systems. In particular, embodiments of the opacity-aware vectorization system generate vector graphics that more accurately represent the visual elements—particularly the transparency and/or translucency—of their corresponding raster images. Indeed, by preparing transparent and/or translucent pixels for segmentation via blending and creating maps that track opacity values, the opacity-aware vectorization system accurately translates transparency and/or translucency from the raster format to the vector format.

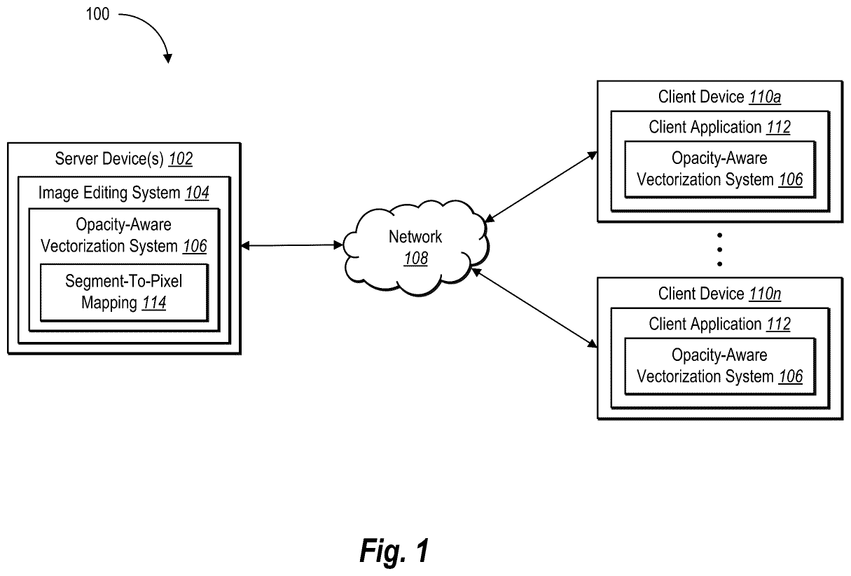

Additional details regarding the opacity-aware vectorization system will now be provided with reference to the figures. For example, FIG. 1 illustrates a schematic diagram of an exemplary system environment (“environment”) 100 in which an opacity-aware vectorization system 106 operates. As illustrated in FIG. 1, the environment 100 includes a server device(s) 102, a network 108, and client devices 110a-110n.

Although the environment 100 of FIG. 1 is depicted as having a particular number of components, the environment 100 is capable of having any number of additional or alternative components (e.g., any number of server devices, client devices, or other components in communication with the opacity-aware vectorization system 106 via the network 108). Similarly, although FIG. 1 illustrates a particular arrangement of the server device(s) 102, the network 108, and the client devices 110a-110n, various additional arrangements are possible.

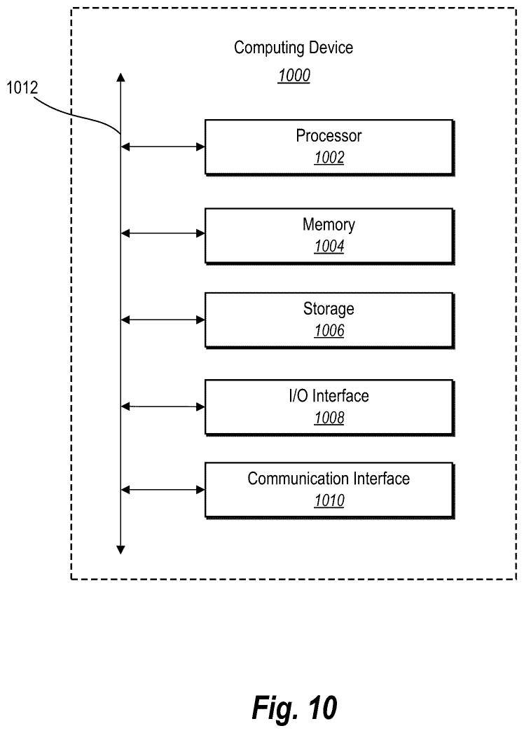

The server device(s) 102, the network 108, and the client devices 110a-110n are communicatively coupled with each other either directly or indirectly (e.g., through the network 108 discussed in greater detail below in relation to FIG. 10). Moreover, the server device(s) 102 and the client devices 110a-110n include one of a variety of computing devices (including one or more computing devices as discussed in greater detail with relation to FIG. 10).

As mentioned above, the environment 100 includes the server device(s) 102. In one or more embodiments, the server device(s) 102 generates, stores, receives, and/or transmits data including raster images and vector graphics generated from the raster imagers. In one or more embodiments, the server device(s) 102 comprises a data server. In some implementations, the server device(s) 102 comprises a communication server or a web-hosting server.

In one or more embodiments, the image editing system 104 provides functionality by which a client device (e.g., a user of one of the client devices 110a-110n) generates, edits, manages, and/or stores raster images and/or vector graphics. For example, in some instances, a client device sends a raster image to the image editing system 104 hosted on the server device(s) 102 via the network 108. The image editing system 104 then provides many options that the client device may use to edit the raster image, store the raster image, and subsequently search for, access, view, and/or use the raster image. For instance, in some cases, the image editing system 104 provides one or more options that the client device may use to generate a vector graphic from the raster image and one or more additional options for editing the vector graphic.

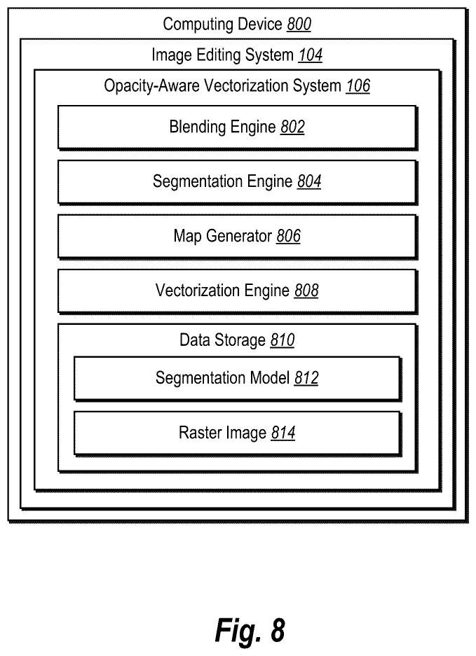

Additionally, the server device(s) 102 includes the opacity-aware vectorization system 106. In one or more embodiments, via the server device(s) 102, the opacity-aware vectorization system 106 blends pixels of a raster image having a transmissive property with one or more color values. Via the server device(s) 102, the opacity-aware vectorization system 106 further extracts segments from the raster image having the modified pixels and maps the segments to the pixels (e.g., via a segment-to-pixel mapping 114), opacity values (e.g., via one or more opacity maps), and color values (e.g., via one or more color maps) from the raster image. The opacity-aware vectorization system 106, via the server device(s) 102, generates a vector image corresponding to the raster image by generating vector paths corresponding to the extracted segments and incorporating the mapped opacity and color values as vector opacity and vector color values, respectively. Example components of the opacity-aware vectorization system 106 will be described below with regard to FIG. 8.

In one or more embodiments, the client devices 110a-110n include computing devices that are capable of accessing, modifying, and/or storing raster images and/or vector graphics. For example, the client devices 110a-110n include smartphones, tablets, desktop computers, laptop computers, head-mounted-display devices, or other electronic devices. The client devices 110a-110n include one or more applications (e.g., the client application 112) that are capable of accessing, modifying, and/or storing raster images and/or vector graphics. For example, in some embodiments, the client application 112 includes a software application installed on the client devices 110a-110n. In other cases, however, the client application 112 includes a web browser or other application that accesses a software application hosted on the server device(s) 102.

One or more embodiments of the opacity-aware vectorization system 106 are implemented in whole, or in part, by the individual elements of the environment 100. Indeed, as shown in FIG. 1, one or more embodiments of the opacity-aware vectorization system 106 are implemented with regard to the server device(s) 102 and/or at the client devices 110a-110n. In particular embodiments, the opacity-aware vectorization system 106 on the client devices 110a-110n comprises a web application, a native application installed on the client devices 110a-110n (e.g., a mobile application, a desktop application, a plug-in application, etc.), or a cloud-based application where part of the functionality is performed by the server device(s) 102.

In additional or alternative embodiments, the opacity-aware vectorization system 106 on the client devices 110a-110n represents and/or provides the same or similar functionality as described herein in connection with the opacity-aware vectorization system 106 on the server device(s) 102. In some implementations, the opacity-aware vectorization system 106 on the server device(s) 102 supports the opacity-aware vectorization system 106 on the client devices 110a-110n.

In some embodiments, the opacity-aware vectorization system 106 includes a web hosting application that allows the client devices 110a-110n to interact with content and services hosted on the server device(s) 102. To illustrate, in one or more implementations, the client devices 110a-110n accesses a web page or computing application supported by the server device(s) 102. The client devices 110a-110n provide input to the server device(s) 102, such as a raster image and a user request for vectorizing the raster image In response, the opacity-aware vectorization system 106 on the server device(s) 102 vectorizes the raster image. The server device(s) 102 then provides the resulting vector graphic to the client devices 110a-110n.

In some embodiments, though not illustrated in FIG. 1, the environment 100 has a different arrangement of components and/or has a different number or set of components altogether. For example, in certain embodiments, the client devices 110a-110n communicate directly with the server device(s) 102 bypassing the network 108. As another example, the environment 100 includes a third-party server device comprising a content server and/or a data collection server.

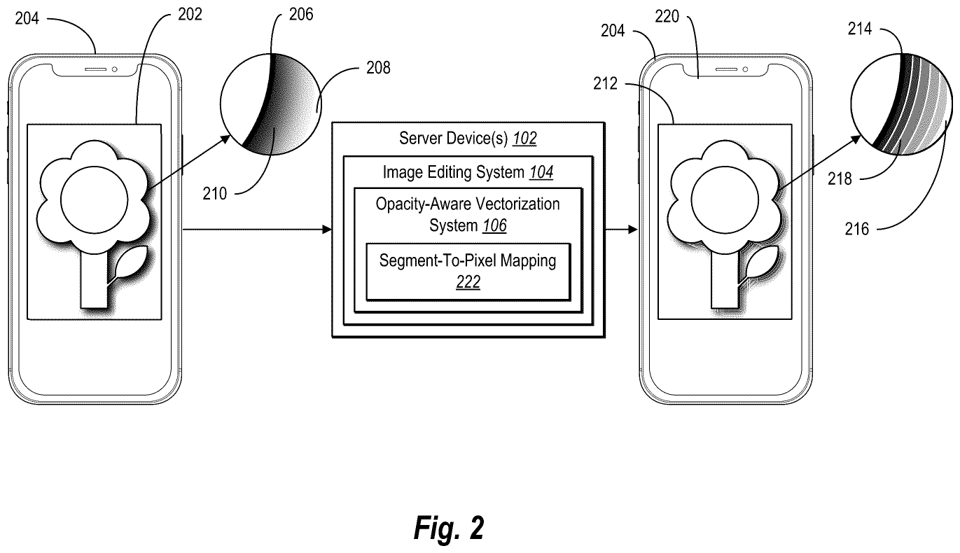

As mentioned, in one or more embodiments, the opacity-aware vectorization system 106 vectorizes a raster image while translating a transmissive property of pixels included therein. In particular, the opacity-aware vectorization system 106 generates a vector graphic that includes the transmissive property. FIG. 2 illustrates the opacity-aware vectorization system 106 vectorizing a raster image while translating a transmissive property depicted therein in accordance with one or more embodiments.

In one or more embodiments, a transmissive property includes a property or attribute of a visual element (e.g., a pixel of a raster image or a vector path of a vector graphic) that causes the visual element to appear less than completely opaque. In particular, in some embodiments, a transmissive property includes a property or attribute of a first visual element that enables a second visual element (e.g., a background of the raster image or vector graphic) positioned behind the first visual element to be at least partially visible. To illustrate, in some cases, a transmissive property includes a property or attribute that causes a visual element to appear at least semi-transparent. Indeed, in some implementations, a transmissive property of a visual element includes a transparency or a translucency (i.e., semi-transparency) of the visual element.

In one or more embodiments, a transmissive pixel includes a pixel having a transmissive property. In particular, in some embodiments, a transmissive pixel includes a pixel that is less than fully opaque. For instance, in some cases, a transmissive pixel includes a pixel having a transparency or a pixel having a translucency. More specifically, in certain instances, a transparent pixel includes a transmissive pixel that is transparent, and a translucent pixel includes a transmissive pixel having a translucent. Similarly, in one or more embodiments, a transmissive vector path includes a vector path having a transmissive property, such that a transparent vector path includes a transmissive vector path that is transparent, and a translucent vector path includes a transmissive vector path that is translucent. As will be discussed in more detail below, in certain embodiments, the degree to which a pixel or vector path is transmissive (or non-transmissive) is controlled or otherwise indicated by a corresponding value.

Indeed, as illustrated in FIG. 2, the opacity-aware vectorization system 106 receives a raster image 202 from a client device 204. The raster image 202 includes at least one transmissive property. In particular, one or more sets of pixels of the raster image 202 have a transmissive property in that the one or more sets of pixels are less than fully opaque. Indeed, as shown in the zoom-in view 206, the raster image 202 includes a set of transparent pixels 208 and a set of translucent pixels 210.

As shown in FIG. 2, the opacity-aware vectorization system 106 vectorizes the raster image 202. In particular, the opacity-aware vectorization system 106 generates a vector graphic 212 that corresponds to the raster image 202. For instance, as will be discussed in more detail below, in certain embodiments, the opacity-aware vectorization system 106 generates one or more vector paths that correspond to one or more segments of the raster image 202. Further, in some cases, the opacity-aware vectorization system 106 translates one or more properties of each segment of the raster image 202 to the corresponding vector path of the vector graphic 212. For example, in some embodiments, the opacity-aware vectorization system 106 translates a transmissive property associated with one or more pixels of a segment to the vector path generated for that segment. Indeed, as shown in the zoomed-in view 214, the opacity-aware vectorization system 106 generates one or more transparent vector paths 216 that correspond to the set of transparent pixels 208 (or otherwise generates vector paths against the background of the vector graphic 212 such that the background is visible within the vector graphic 212). Further, the opacity-aware vectorization system 106 generates one or more translucent vector paths 218 that correspond to the set of translucent pixels 210.

As illustrated in FIG. 2, the opacity-aware vectorization system 106 provides the vector graphic 212 for display on the client device 204. In particular, the opacity-aware vectorization system 106 provides the vector graphic 212 for display within a graphical user interface 220 of the client device 204. In some cases, the opacity-aware vectorization system 106 enables further interaction with the vector graphic 212 through the graphical user interface 220.

As shown in FIG. 2, the opacity-aware vectorization system 106 uses a segment-to-pixel mapping 222 in generating the vector graphic 212 from the raster image 202. In one or more embodiments, a segment-to-pixel mapping includes a mapping of segments of a raster image to pixels of the raster image. In particular, in some embodiments, a segment-to-pixel mapping includes a mapping of a segment of a raster image to the pixels of the raster image that are included in that segment. For instance, in some cases, a segment-to-pixel mapping maps a segment extracted from a raster image (discussed more below) to each pixel (e.g., the pixel coordinates) that contributes to the portrayal of the segment within the raster image. To illustrate, in some instances, a segment-to-pixel mapping includes a map that includes segments (e.g., segment IDs) as the keys and pixels (e.g., the pixel coordinates) as the values. In some cases, a segment-to-pixel mapping includes additional information as the values, such as opacity values, color values, and/or other pixel related information of the relevant pixels.

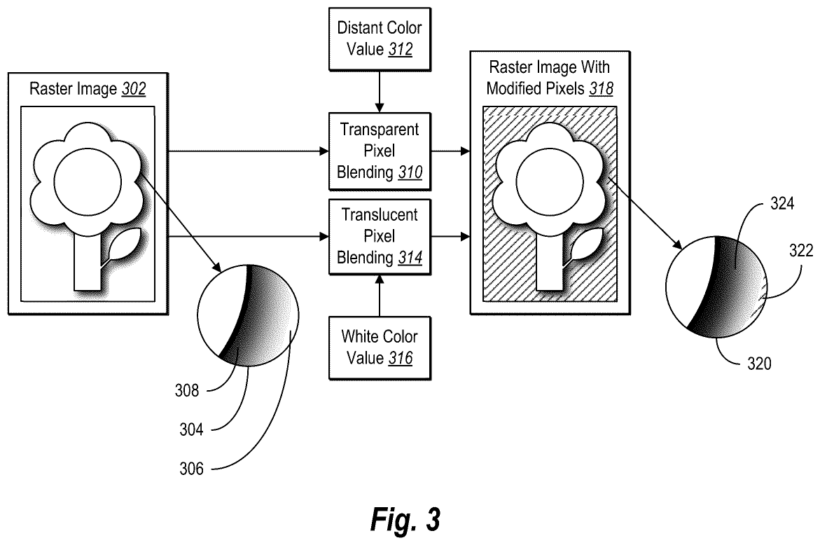

As mentioned, in one or more embodiments, the opacity-aware vectorization system 106 vectorizes a raster image by modifying pixels of the raster image having a transmissive property. FIG. 3 illustrates the opacity-aware vectorization system 106 modifying the pixels of a raster image having a transmissive property in accordance with one or more embodiments.

Indeed, FIG. 3 illustrates a raster image 302 having at least one transmissive property. In particular, as illustrated by the zoomed-in view 304, the raster image 302 includes a set of transparent pixels 306 and a set of translucent pixels 308.

As indicated by FIG. 3, the opacity-aware vectorization system 106 modifies the set of transparent pixels 306 and the set of translucent pixels 308 by blending each set of pixels with a color value. In one or more embodiments, a color value includes a value representing a color. In particular, in some embodiments, a color value includes a numerical representation of a color. For instance, in some cases, a color value includes a numerical value that enables or causes a corresponding color to be displayed by a graphical system, such as within a raster image or a vector graphic. Indeed, in some cases, a color value includes a set of numerical values that specify the intensity or proportion of color components that make up the corresponding color. A color value includes, but is not limited to, a color value in a red, blue, green (RGB) color format or a cyan, magenta, yellow, and key (CMYK) color format.

As indicated by FIG. 3, the opacity-aware vectorization system 106 modifies the set of transparent pixels 306 by performing transparent pixel blending 310 using a distant color value 312. In one or more embodiments, a distant color value includes a color value that differs from other color values within a set. In particular, in some embodiments, a distant color value includes a color value that differs from the color values represented within a raster image. For instance, in some cases, a distant color value includes a color value that is determined to be the farthest (e.g., within a color space) color value from all color values present in a raster image. In one or more embodiments, the opacity-aware vectorization system 106 determines the distant color value 312 using a random color generation model, a color space sampling model, or a convex hull algorithm (or a technique based upon such an algorithm).

In some embodiments, the opacity-aware vectorization system 106 receives one or more color values via user input and determines the distant color value 312 further based on the user input. In particular, the opacity-aware vectorization system 106 determines the distant color value 312 to be a color value that differs from the color values included in the raster image 302 raster image and one or more color values received via user input. Thus, in some cases, the opacity-aware vectorization system 106 enables user input to define additional colors for use in determining the distant color value 312.

In one or more embodiments, the opacity-aware vectorization system 106 blends the distant color value 312 with the set of transparent pixels 306 by filling the set of transparent pixels 306 with the distant color value 312. Indeed, as the set of transparent pixels 306 are transparent (e.g., a background of the raster image is visible via the set of transparent pixels 306), the opacity-aware vectorization system 106 fills in the pixels with the distant color value 312. Thus, in some embodiments, the opacity-aware vectorization system 106 modifies the set of transparent pixels 306 to appear fully opaque such that the distant color value 312 is the only color value that is portrayed by the modified pixels.

Similarly, as shown in FIG. 3, the opacity-aware vectorization system 106 modifies the set of translucent pixels 308 of the raster image 302 by performing translucent pixel blending 314 using a white color value 316. Although FIG. 3 shows use of the white color value 316, the opacity-aware vectorization system 106 uses another color value in certain embodiments.

In particular, in one or more embodiments, the opacity-aware vectorization system 106 determines or defines the color value of a translucent pixel as follows:

$${C}_{result} = α \cdot {C}_{b a s e} + ( 1 - α ) \cdot {C}_{background} \qquad ( 1 )$$

In equation 1, Chase represents the base color value for the pixel. In one or more embodiments, a base color value includes the primary color value of a visual element, such as a pixel of a raster image or a vector path of a vector graphic). In particular, in some embodiments, a base color value includes the primary color value of the portion of a raster image being portrayed by a pixel or of the portion of a vector graphic being portrayed by a vector path. For instance, in some embodiments, a base color value includes the color value of a front-most portion of a raster image portrayed by a pixel or of a vector graphic portrayed by a vector path (e.g., a portion in the foreground, at a topmost layer, or otherwise unobstructed by other portions). In some cases, a base color value of a visual element (e.g., a pixel or vector path) includes the color value that would be visible were the visual element completely opaque.

Additionally, in equation 1, C_{background} represents a background color value for the raster image 302. In one or more embodiments, a background color value includes a color value of the background of a raster image or vector graphic.

Further, in equation 1, α represents the opacity value for the pixel. In one or more embodiments, an opacity value includes a value representing opacity. In particular, in some embodiments, an opacity value includes a numerical representation of a level (e.g., degree) of opacity. In some cases, an opacity value includes a numerical value that enables or causes a color to be displayed by a graphical system—such as within a raster image or a vector graphic—with a corresponding level of opacity. For example, in some implementations, an opacity value includes a value in the range of 0 to 1 (or 255, such as in an 8-bit representation) where an opacity value of 0 indicates full transparency, an opacity value of 1 (or 255) indicates fully opaque, and an opacity value in between indicates translucency (i.e., semi-transparency). The opacity-aware vectorization system 106, however, uses other value ranges and values to indicate different levels of opacity in various implementations. In some cases, an opacity value corresponds to or is indicated by the alpha channel of a raster image or a vector graphic.

Thus, as shown by equation 1, the opacity-aware vectorization system 106 determines or defines the color value of a translucent pixel as a mix or blend between the base color value for the pixel and the background color value for the background of the raster image 302. Further, the amount of each color value in the mixture is controlled or defined by the opacity value. As such, in one or more embodiments, the opacity-aware vectorization system 106 performs the translucent pixel blending 314 shown in FIG. 3 by blending the base color value of the pixel with the white color value 316 using equation 1 so that the representation of the base color value and the white color value 316 in the blend is defined by a (the opacity level). For instance, in some embodiments, the opacity-aware vectorization system 106 replaces C_{background} with the white color value 316 in equation 1.

In one or more embodiments, the opacity-aware vectorization system 106 uses an opacity threshold when blending translucent pixels of the raster image 302. In one or more embodiments, an opacity threshold includes a threshold opacity value. In particular, in some embodiments, an opacity threshold includes an opacity value used as a threshold for determining how a translucent pixel is handled when blending the translucent pixels of a raster image. For instance, in some implementations, an opacity threshold defines a minimum level of opacity required for a translucent pixel to be modified via the translucent pixel blending 314.

To illustrate, in some cases, the opacity-aware vectorization system 106 determines an opacity threshold and further compares the opacity value of a translucent pixel to opacity threshold. If the opacity level satisfies the opacity threshold (e.g., is equal to or greater than the opacity threshold such that the opacity level meets or exceeds the minimum level of opacity defined by the opacity threshold), the opacity-aware vectorization system 106 modifies the translucent pixel via the translucent pixel blending 314. In other words, the opacity-aware vectorization system 106 blends the base color value of the translucent pixel with the white color value 316. On the other hand, if the opacity level fails to satisfy the opacity threshold (e.g., is less than the opacity threshold such that the opacity level fails to reach the minimum level of opacity defined by the opacity threshold), the opacity-aware vectorization system 106 modifies the translucent pixel via the transparent pixel blending 310. In other words, the opacity-aware vectorization system 106 treats the translucent pixel as if it were fully transparent and fills the translucent pixel with the distant color value 312.

Thus, as shown in FIG. 3, the opacity-aware vectorization system 106 uses the transparent pixel blending 310 and the translucent pixel blending 314 to modify the raster image 302. In particular, the opacity-aware vectorization system 106 modifies the set of transparent pixels 306 and the set of translucent pixels 308 within the raster image 302 to produce a modified version of the raster image 302 (i.e., the raster image 318 with modified pixels). Indeed, the zoomed-in view 320 shows modified transparent pixels 322 and modified translucent pixels 324.

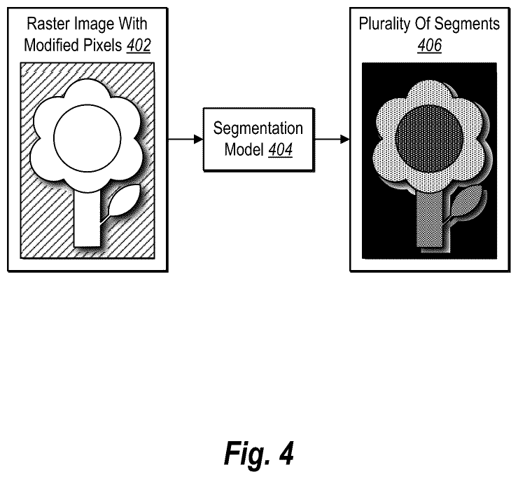

As mentioned, in one or more embodiments, the opacity-aware vectorization system 106 vectorizes a raster image by extracting one or more segments from the raster image. In particular, in some embodiments, the opacity-aware vectorization system 106 extracts one or more segments from a raster image having pixels modified via transparent pixel blending and/or translucent pixel blending. FIG. 4 illustrates, the opacity-aware vectorization system 106 extracting segments from a raster image in accordance with one or more embodiments.

As shown in FIG. 4, the opacity-aware vectorization system 106 provides a raster image 402 having modified pixels (e.g., pixels modified via transparent pixel blending and/or pixels modified via translucent pixel blending as discussed with reference to FIG. 3) to a segmentation model 404. In one or more embodiments, a segmentation model includes a computer-implemented model that extracts one or more segments from an image, such as a raster image or a vector graphic. In particular, in some embodiments, a segmentation model includes a computer-implemented model that analyzes an image and extracts one or more distinct segments of the image based on the analysis. In certain embodiments, a segmentation model extracts high-level segments (e.g., objects, foreground, or background) or low-level segments (e.g., parts or sub-parts) from an image. Indeed, in some cases, a segmentation model extracts a plurality of segments from an image where each segment corresponds to a distinct and separately identifiable portion of the image.

The opacity-aware vectorization system 106 uses various models at the segmentation model 404 in various embodiments. For example, in some cases, the opacity-aware vectorization system 106 uses a machine learning model as the segmentation model 404.

In one or more embodiments, a machine learning model includes a computer-implemented model that can be tuned (e.g., trained) based on inputs to approximate unknown functions. In particular, in some embodiments, a machine-learning model includes a model that utilizes algorithms to learn from, and make predictions on, known data by analyzing the known data to learn to generate outputs that reflect patterns and attributes of the known data. For instance, in some cases, a machine-learning model includes, but is not limited to, a neural network (e.g., a convolutional neural network, recurrent neural network or other deep learning network), a decision tree (e.g., a gradient boosted decision tree), association rule learning, inductive logic programming, support vector learning, Bayesian network, regression-based model (e.g., censored regression), principal component analysis, or a combination thereof.

In one or more embodiments, a neural network includes a model of interconnected artificial neurons (e.g., organized in layers) that communicate and learn to approximate complex functions and generate outputs based on inputs provided to the model. In some instances, a neural network includes one or more machine learning algorithms. Further, in some cases, a neural network includes an algorithm (or set of algorithms) that implements deep learning techniques that utilize a set of algorithms to model high-level abstractions in data. To illustrate, in some embodiments, a neural network includes a convolutional neural network, a recurrent neural network (e.g., a long short-term memory neural network), a generative adversarial network, a graph neural network, a multi-layer perceptron, or a diffusion neural network. In some embodiments, a neural network includes a combination of neural networks or neural network components.

Indeed, as shown in FIG. 4, the opacity-aware vectorization system 106 uses the segmentation model 404 to extract a plurality of segments 406 from the raster image 402. In some embodiments, the opacity-aware vectorization system 106 generates a segmentation map or a spatial map using the extracted segments. As further shown in FIG. 4, one or more of the segments include modified transparent pixels (e.g., transparent pixels blended with a distant color value), and one or more of the segments include modified translucent pixels (e.g., translucent pixels blended with an additional color value, such as a white color value).

By performing segmentation on a raster image having transparent and/or translucent pixels that have been modified, the opacity-aware vectorization system 106 operates more flexibly than conventional systems. For instance, by modifying the transparent and/or translucent pixels via blending and performing segmentation on the blended pixels, the opacity-aware vectorization system 106 enables the pixels to be viewed as fully opaque by the segmentation model. Thus, the opacity-aware vectorization system 106 enables the segmentation model to flexibly extract segments of a raster image having transparent and/or translucent pixels. This is particularly true with respect to translucent pixels as conventional systems. While conventional systems typically drop translucency completely by either converting translucent pixels to completely opaque or completely transparent, the opacity-aware vectorization system 106 flexibly maintains the translucency of the pixels—e.g., the strength of appearance of their base color value—by blending the base color value with an additional color value.

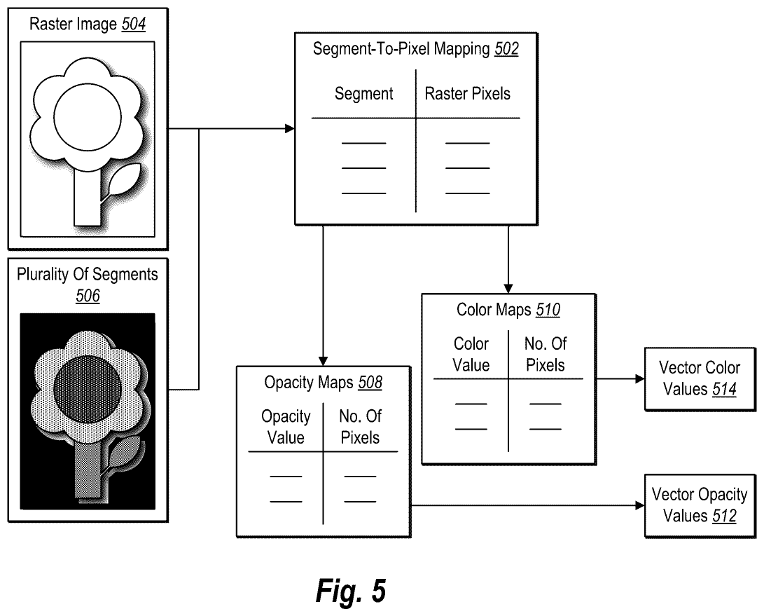

As previously mentioned, in one or more embodiments, the opacity-aware vectorization system 106 vectorizes a raster image by generating a segment-to-pixel mapping for the raster image. FIG. 5 illustrates the opacity-aware vectorization system 106 generating a segment-to-pixel mapping for a raster image in accordance with one or more embodiments.

As shown in FIG. 5, the opacity-aware vectorization system 106 generates a segment-to-pixel mapping 502 from a raster image 504 and a plurality of segments 506 extracted from the raster image 504. In one or more embodiments, the opacity-aware vectorization system 106 extracts the plurality of segments 506 as described above with reference to FIGS. 3-4 (e.g., by modifying transparent pixels and/or translucent pixels of the raster image 504 and extracting the plurality of segments 506 from the modified result). As shown in FIG. 5, the segment-to-pixel mapping maps the plurality of segments 506 to their corresponding pixels from the raster image 504. For instance, in some cases, the segment-to-pixel mapping 502 maps each segment to the pixels of the raster image 504 that contribute to (e.g., are positioned in) that segment. In some cases, the opacity-aware vectorization system 106 maps a pixel from the raster image 504 to a segment by mapping a coordinate of the pixel within the raster image 504 to the segment.

Additionally, as shown in FIG. 5, the opacity-aware vectorization system 106 generates opacity maps 508 from the segment-to-pixel mapping 502 or generates the opacity maps 508 as part of the segment-to-pixel mapping 502. In one or more embodiments, an opacity map includes a mapping of pixels of a raster image to opacity values included in the raster image. For instance, in some cases, an opacity map includes a mapping of opacity values to the number of pixels having those opacity values. To illustrate, in some instances, an opacity map includes a map having opacity values as the keys and the number of pixels having the opacity values as the corresponding values.

In one or more embodiments, the opacity-aware vectorization system 106 generates the opacity maps 508 by generating an opacity map for each segment from the plurality of segments 506. Thus, in some embodiments, the opacity-aware vectorization system 106 generates an opacity map to associate a segment of a raster image with the opacity values of that segment. In particular, the opacity-aware vectorization system 106 generates the opacity map to map each opacity value represented in the segment to the number of pixels of the segment having the opacity value. In some cases, the opacity-aware vectorization system 106 maps the opacity map corresponding to a segment to that segment within the segment-to-pixel mapping 502.

As shown in FIG. 5, the opacity-aware vectorization system 106 also generates the color maps 510 from the segment-to-pixel mapping 502 or generates the color maps 510 as part of the segment-to-pixel mapping 502. In one or more embodiments, a color map includes a mapping of pixels of a raster image to color values included in the raster image. For instance, in some cases, a color map includes a mapping of color values to the number of pixels having those color values. To illustrate, in some instances, a color map includes a map having color values as the keys and the number of pixels having the color values as the corresponding values.

In one or more embodiments, the opacity-aware vectorization system 106 generates the color maps 510 by generating a color map for each segment from the plurality of segments 506. Thus, in some embodiments, the opacity-aware vectorization system 106 generates a color map to associate a segment of a raster image with the color values of that segment. In particular, the opacity-aware vectorization system 106 generates the color map to map each color value represented in the segment to the number of pixels of the segment having the color value. In some cases, the opacity-aware vectorization system 106 maps the color map corresponding to a segment to that segment within the segment-to-pixel mapping 502.

Algorithm 1 presented below represents another characterization of the opacity-aware vectorization system 106 generates the segment-to-pixel mapping 502 (and the opacity maps 508 and color maps 510) in accordance with one or more embodiments.

Algorithm 1

```
FUNCTION GenerateSPMap (segmentationData, sourceImage, SPMap):
  FOR each pixel (x,y) in sourceImage:
    segmentId = segmentationData.getSegmentId(x,y)
    pixel = sourceImage.getPixel(x,y)
    IF segmentId does not exist in SPMap:
      SPMap[segmentId] = CREATE_OBJECT(SPMap)
    segmentInfo = SPMap[segmentId]
    segmentInfo.opacityMap[pixel.opacity] = segmentInfo.opacityMap.get(pixel.opacity,0) + 1
    segmentInfo.colorMap[pixel.color] = segmentInfo.colorMap.get(pixel.color,0) + 1
  ...
  ... // Store other pixel level details for each segment
  ...
  END FOR
END FUNCTION
```

As shown by the first line, in certain embodiments, the opacity-aware vectorization system 106 generates the segment-to-pixel mapping 502 (SPMap) using the plurality of segments 506 and/or other data obtained via segmentation of the raster image 504 (segmentationData), the raster image 504 (sourceImage), and an initialized version of the segment-to-pixel mapping 502. Lines 3-4 indicate that the opacity-aware vectorization system 106 identifies the ID for a given segment from the segmentation data and identifies a pixel from the source image, respectively. Lines 5-6 indicates that the opacity-aware vectorization system 106 creates an entry within the segment-to-pixel mapping 502 for the segment ID if one does not already exist. Lines 7-9 indicate that, for that entry for the segment ID, the opacity-aware vectorization system 106 builds an opacity map and a color map using the opacity value and color value, respectively, of the pixel. Thus, in some cases, the opacity-aware vectorization system 106 uses the segment-to-pixel mapping 502 to map a segment to its pixels, opacity values, and color values within the raster image 504.

As shown in FIG. 5, the opacity-aware vectorization system 106 determines vector opacity values 512 from the opacity maps 508 and determines vector color values 514 from the color maps 510. In one or more embodiments, a vector opacity value includes an opacity value for a vector path of a vector graphic. Similarly, in some embodiments, a vector color value includes a color value for a vector path of a vector graphic (e.g., a fill color or a stroke color). Thus, while an opacity value or color value includes a value for a raster image or a vector graphic, a vector opacity value or vector color value more specifically includes a value for a vector graphic.

In one or more embodiments, the opacity-aware vectorization system 106 determines the vector opacity values 512 from the opacity maps 508 by determining a vector opacity value from each opacity map. Likewise, in some embodiments, the opacity-aware vectorization system 106 determines the vector color values 514 from the color maps 510 by determining a vector color value from each color map. Thus, in some instances, the opacity-aware vectorization system 106 determines a vector opacity value and a vector color value for a vector path to be generated from a segment of the raster image 504 using the opacity map and color map, respectively, that correspond to that segment.

In one or more embodiments, the opacity-aware vectorization system 106 determines a vector opacity value from an opacity map based on the opacity values represented in the map. For instance, in some cases, the opacity-aware vectorization system 106 uses a weighted average of the opacity values represented in the opacity map determined as follows:

$$Weighted Average Opacity = \frac{{\sum }_{i} ( {Opacity}_{i} * {Weight}_{i} )}{{\sum }_{i} {Weight}_{i}} \qquad ( 2 )$$

In equation 2, Opacityᵢ represents the opacity value of the ith pixel, and Weightᵢ scales the contribution of each Opacityᵢ based on its relative importance within the segment. For instance, in some cases, the opacity-aware vectorization system 106 assigns a higher weight to an opacity value that occurs more frequently in a segment (e.g., more pixels have that opacity value) and a lower weight to an opacity value that occurs less frequently in the segment (e.g., fewer pixels have that opacity value). Thus, in some cases, the opacity-aware vectorization system 106 uses the weights to control the influence of an opacity value of a segment when determining a vector opacity value for the corresponding vector path to be generated from the segment. In some cases, rather than a weighted average opacity, the opacity-aware vectorization system 106 uses a standard average opacity or the opacity value with the most representation in the segment in determining the vector opacity value.

In some cases, the opacity-aware vectorization system 106 uses the weighted average opacity (or standard average or most represented opacity value) as the vector opacity value. In some cases, however, the opacity-aware vectorization system 106 uses a corresponding opacity value formatted for vector graphics or the relevant image editing application as the vector opacity value. For instance, in some cases, opacity values and/or their formatting differ between raster images and vector graphics or differ between image editing applications. As such, in certain cases, the opacity-aware vectorization system 106 uses a vector opacity value that corresponds to (e.g., is a nearest equivalent to) the weighted average opacity determined based on the opacity map generated from the raster image 504.

In one or more embodiments, the opacity-aware vectorization system 106 determines a vector color value from a color map based on the color values represented in the map. In some cases, the opacity-aware vectorization system 106 determines the vector color value by extracting a representative color value from the color values represented in the map. In some cases, the opacity-aware vectorization system 106 determines the representative color value to be the color value with the highest representation within the segment corresponding to the color map. Thus, the opacity-aware vectorization system 106 determines the representative color value to be the color value associated with the highest number of pixels within the color map. In some instances, the opacity-aware vectorization system 106 uses other methods (e.g., weighted average or standard average) to determine the representative color value.

In some cases, the opacity-aware vectorization system 106 uses the representative color value as the vector color value. In some cases, however, the opacity-aware vectorization system 106 uses a corresponding color value formatted for vector graphics or the relevant image editing application as the vector color value. For instance, in some cases, color values and/or their formatting differ between raster images and vector graphics or differ between image editing applications. As such, in certain cases, the opacity-aware vectorization system 106 uses a vector color value that corresponds to (e.g., is a nearest equivalent to) the representative color value determined based on the color map generated from the raster image 504.

In one or more embodiments, upon determining the vector opacity values 512 from the segments of the raster image 504 (e.g., determining the vector opacity value for each vector path to be generated from a segment of the raster image 504), the opacity-aware vectorization system 106 modifies the vector opacity values 512 using an opacity smoothing model. For instance, in some embodiments, the opacity-aware vectorization system 106 uses the opacity smoothing model to, for a given vector path, modify the vector opacity values of neighboring vector paths based on their spatial relationships. Thus, in some instances, the opacity-aware vectorization system 106 adjusts the vector opacity values of a plurality of vector paths to ensure a smoother transition of opacity across vector paths, producing a more natural gradient in the resulting vector graphic and preserving the visual effects from the raster image 504.

Additionally, in one or more embodiments, upon determining the vector color values 514 from the segments of the raster image 504 (e.g., determining the vector color value for each vector path to be generated from a segment of the raster image 504), the opacity-aware vectorization system 106 modifies the vector color values 514 using a color equalizer model. For instance, in some embodiments, the opacity-aware vectorization system 106 uses the color equalizer model to, for a given vector path, modify the vector color values of neighboring vector paths based on their spatial relationships. Thus, in some instances, the opacity-aware vectorization system 106 adjusts the vector opacity values of a plurality of vector paths to avoid incorrect boundary highlights and effectively handle certain outlier cases.

Algorithm 2 presented below represents another characterization of the opacity-aware vectorization system 106 determining vector opacity values and vector color values to be used in a vector graphic generated from a raster image in accordance with one or more embodiments.

Algorithm 2

```
FUNCTION ComputeTranslucencyInfo (SPMap):
  segmentTranslucencyInfo = { }
  FOR each segmentEntry in SPMap:
    segmentId = segmentEntry.key
    segmentInfo = segmentEntry.value
    //get the representative opacity for the segment
    opacity = GetRepresentativeOpacity(segmentInfo.opacityMap)
    //get the representative color for the segment
    color = GetRepresentativeColor(segmentInfo.colorMap)
    //store computed opacity, color in the map with segmentId as the key
    segmentTranslucencyInfo[segmentId] = (opacity, color)
  END FOR
  OpacitySmoother(segmentTranslucencyInfo)
  ColorEqualizer(segmentTranslucencyInfo)
END FUNCTION
```

As shown in algorithm 2, the opacity-aware vectorization system 106 computes the vector opacity value and vector color value for each segment using the information stored in the segment-to-pixel mapping 502 (including the information from the opacity maps 508 and the color maps 510). The opacity-aware vectorization system 106 further stores this information, such as within the segment-to-pixel mapping 502. Thus, in some cases, the opacity-aware vectorization system 106 uses the segment-to-pixel mapping 502 to further map a vector opacity value and a vector color value to each segment. Indeed, the above discusses determining vector opacity values and vector color values for segments or for vector paths. It should be understood that, in some cases, the opacity-aware vectorization system 106 determines the vector opacity values and vector color values for vector paths that have yet to be generated. Further, the vector paths to be generated correspond to segments extracted from the raster image 504. Thus, a vector opacity value or a vector color value corresponds to a segment of the raster image 504 in that the opacity-aware vectorization system 106 will use the vector opacity value or the vector color value for the vector path to be generated from the segment. As such, mapping vector opacity values and vector color values to segments allows the opacity-aware vectorization system 106 to apply the values correctly to the vector paths created from these segments.

Indeed, by vectorizing a raster image using a segment-to-pixel mapping (and the opacity maps and color maps), the opacity-aware vectorization system 106 operates with improved flexibility and accuracy when compared to conventional systems. For example, as just mentioned, mapping the segments of a raster image to their corresponding pixels, opacity values, color values, vector opacity values, and/or vector color values enables the opacity-aware vectorization system 106 to flexibly translate the transparency and/or translucency of a raster image to the vector graphic generated from the raster image. Thus, rather than implementing the workarounds of conventional systems—such as dropping translucency completely—the opacity-aware vectorization system 106 stores the attributes of a raster image, each mapped to the proper segment, for application to the resulting vector path. As such, the opacity-aware vectorization system 106 produces a vectorized result that more accurately resemble the initial raster image and preserves its visual effects.

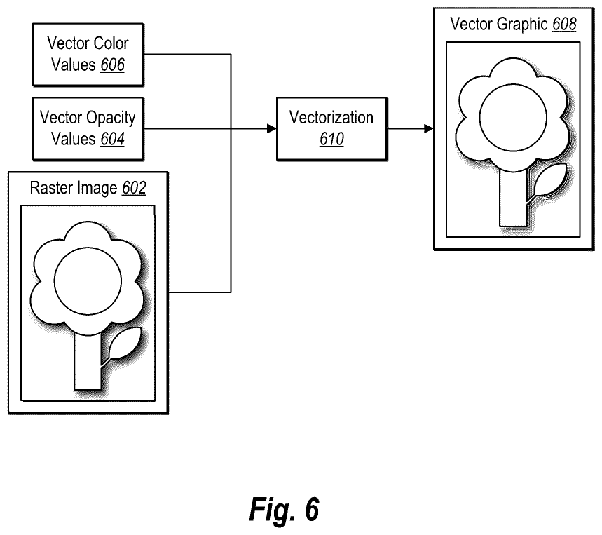

As mentioned, in one or more embodiments, the opacity-aware vectorization system 106 vectorizes a raster image by generating a vector graphic that includes one or more vector paths corresponding to one or more segments of the raster image. FIG. 6 illustrates, the opacity-aware vectorization system 106 generating a vector graphic from a raster image in accordance with one or more embodiments.

As shown in FIG. 6, the opacity-aware vectorization system 106 uses a raster image 602 (e.g., the segments extracted from the raster image 602) as well as vector opacity values 604 and vector color values 606 determined from the raster image 602 to generate a vector graphic 608. In one or more embodiments, the opacity-aware vectorization system 106 determines the vector opacity values 604 and the vector color values 606 as discussed above with respect to FIG. 5. For instance, in some cases, the opacity-aware vectorization system 106 determines the vector opacity values 604 and the vector color values 606 based on opacity values and color values determined from the pixels of the raster image 602 and mapped to the segments extracted therefrom (e.g., mapped via a segment-to-pixel mapping, opacity maps, and/or color maps).

As further shown in FIG. 6, the opacity-aware vectorization system 106 generates the vector graphic 608 via a vectorization process 610. In one or more embodiments, the opacity-aware vectorization system 106 performs the vectorization process 610 by generating vector paths that correspond to the segments extracted from the raster image 602. In particular, the opacity-aware vectorization system 106 generates one or more vector paths that correspond to each extracted segment. Further, in some embodiments, the opacity-aware vectorization system 106 performs the vectorization process 610 by applying the vector opacity values 604 and the vector color values 606 to the generated vector paths. In particular, the opacity-aware vectorization system 106 applies a vector opacity value and a vector color value to the one or more vector paths generated for a segment of the raster image 602. More specifically, the opacity-aware vectorization system 106 applies the vector opacity value and vector color value determined from an extracted segment to the one or more vector paths that correspond to that segment.

Thus, in one or more embodiments, the opacity-aware vectorization system 106 generates a vector graphic from a raster image by modifying translucent pixels and/or transparent pixels of the raster image. The opacity-aware vectorization system 106 extracts segments from the raster image having the modified pixels via a segmentation model. Further, the opacity-aware vectorization system 106 generates a segment-to-pixel mapping (as well as opacity maps and color maps) that maps pixels as well as opacity values and color values of the pixels to the segments. From this mapped information, the opacity-aware vectorization system 106 determines vector opacity values for the vector paths to be generated from the segments (e.g., by determining a weighted average opacity for each segment). Further, the opacity-aware vectorization system 106 determines vector color values for the vector paths (e.g., by determining a representative color value for each segment). The opacity-aware vectorization system 106 generates the vector graphic by generating vector paths that correspond to the extracted segments and incorporating the determined vector opacity values and vector color values into the vector paths.

By generating a vector graphic from a raster image via the vectorization pipeline described above, the opacity-aware vectorization system 106 operates with improved flexibility when compared to conventional systems. Indeed, the opacity-aware vectorization system 106 flexibly manages the transparency and/or translucency of a raster image, translating those attributes to the resulting vector graphic As such, the opacity-aware vectorization system 106 produces a vector graphic with visual effects that more accurately represents the visual effects of the source raster image.

By managing the transparency and/or translucency of a raster image as described above, the opacity-aware vectorization system 106 further provides more flexibility and accuracy with respect to the vectorization of certain raster images. In particular, as mentioned above, the methods of many conventional systems fail to properly vectorize raster images that include a transparency and/or a translucency portrayed in a radial gradient. Such systems often produce vector graphics having unintended hollow regions. By using the pipeline discussed above, however, the opacity-aware vectorization system 106 generates vector paths that accurately portray the transparency and/or translucency in the radial gradient.

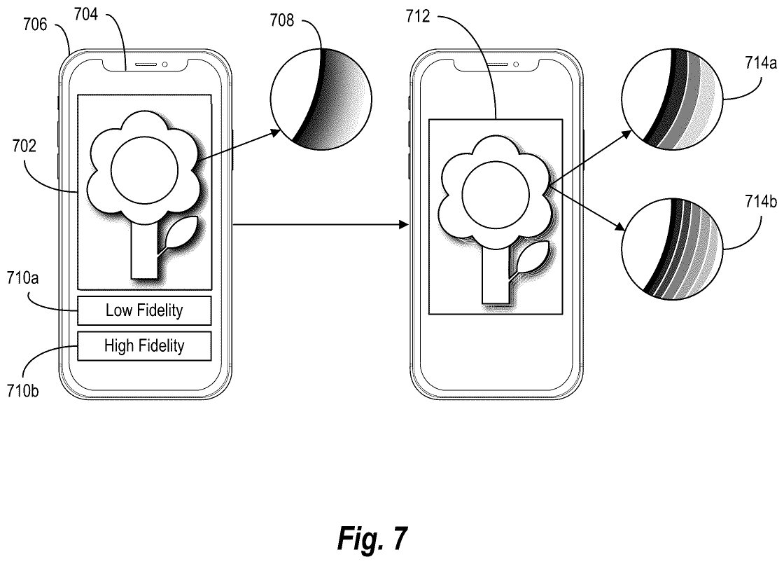

In one or more embodiments, the opacity-aware vectorization system 106 vectorizes a raster image based on a user defined setting. For instance, in some cases, the opacity-aware vectorization system 106 produces a number of vector paths corresponding to extracted segments based on a user defined setting. FIG. 7 illustrates the opacity-aware vectorization system 106 vectorizing a raster image based on a user defined setting in accordance with one or more embodiments.

Indeed, as previously mentioned, in some cases, the opacity-aware vectorization system 106 generates one or more vector paths for each segment extracted from a raster image. Thus, in some implementations, the number of vector paths generated from a segment of a raster image is configuration. In such embodiments, the opacity-aware vectorization system 106 uses a user defined setting to determine a number of vector paths to generate for each segment or for particular segments.

As shown in FIG. 7, the opacity-aware vectorization system 106 provides a raster image 702 for display within a graphical user interface 704 of a client device 706. As indicated by the zoomed-in view 708, the raster image 702 includes transparent pixels and translucent pixels. Specifically, the translucency of the pixels (e.g., their opacity values) change linearly towards full transparency as they extend farther away from the border of the object depicted therein. As further shown in FIG. 7, the opacity-aware vectorization system 106 also provides a first selectable option 710a and a second selectable option 710b for vectorizing the raster image 702.

As illustrated, the first selectable option 710a corresponds to a low-fidelity vectorization of the raster image 702, and the second selectable option 710b corresponds to a high-fidelity vectorization. In one or more embodiments, the fidelity corresponds to the number of vector paths to be generated for a segment. For instance, in some cases, the fidelity corresponds to the number of vector paths to be generated for segments having translucent pixels, particularly segments where the level of translucency (e.g., the opacity level) changes throughout the segment. Thus, in some implementations, the opacity-aware vectorization system 106 performs a high-fidelity vectorization by generating relatively more vector paths for such segments, which more accurately captures the change in translucency portrayed in the raster image.

Indeed, FIG. 7 illustrates a vector graphic 712 generated from the raster image 702, a first zoomed-in view 714a illustrating a portion of the vector graphic 712 that results from selection of the first selectable option 710a for low-fidelity vectorization, and a second zoomed-in view 714b illustrating the same portion but resulting from selection of the second selectable option 710b for high-fidelity vectorization. The portion of the vector graphic 712 shown by the zoomed-in views 714a-714b correspond to the segment of the raster image 702 with transparent and translucent pixels shown in the zoomed-in view 708. As illustrated, the high-fidelity vectorization results in more vector paths corresponding to the translucent pixels when compared to the low-fidelity vectorization. Thus, the high-fidelity vectorization results more accurately capture the gradual change of translucency portrayed by the raster image 702 when compared to the low-fidelity vectorization.

In one or more embodiments, the opacity-aware vectorization system 106 incorporates the fidelity option that has been selected during the vectorization process. For instance, the opacity-aware vectorization system 106 detects a user selection of the first selectable option 710a or the second selectable option 710b and generates the vector graphic 712 in accordance with the selection. In some cases, the opacity-aware vectorization system 106 implements the selected fidelity option by using one or more opacity thresholds to divide segments of the raster image 702 having a changing translucency based on the opacity levels of the pixels included therein (or by extracting segments during segmentation based on the opacity thresholds). Thus, in some embodiments, where a portion of a raster image includes linearly changing translucency as depicted in FIG. 7, the opacity-aware vectorization system 106 determines multiple segments for that portion, generates a separate vector path for each of those segments, and applies the vector opacity value and vector color value determined from each segment to the vector path generated from that segment.

Turning now to FIG. 8, additional detail will now be provided regarding various components and capabilities of the opacity-aware vectorization system 106. In particular, FIG. 8 illustrates the opacity-aware vectorization system 106 implemented by the computing device 800 (e.g., the server device(s) 102 and/or one of the client devices 110a-110n discussed above with reference to FIG. 1). Additionally, the opacity-aware vectorization system 106 is part of the image editing system 104. As shown in FIG. 8, the opacity-aware vectorization system 106 includes, but is not limited to, a blending engine 802, a segmentation engine 804, a map generator 806, a vectorization engine 808, and data storage 810 (which includes segmentation model 812 and raster image 814).

As just mentioned, and as illustrated in FIG. 8, the opacity-aware vectorization system 106 includes the blending engine 802. In one or more embodiments, the blending engine 802 modifies transparent pixels and/or translucent pixels of a raster image to be vectorized. For instance, in some embodiments, the blending engine 802 modifies the pixels by blending the pixels with a determined color value. To illustrate, in certain implementations, the blending engine 802 blends transparent pixels with a distant color value and/or blends translucent pixels with a white color value.

Additionally, as shown in FIG. 8, the opacity-aware vectorization system 106 includes the segmentation engine 804. In one or more embodiments, the segmentation engine 804 extracts segments from a raster image. In particular, in some embodiments, the segmentation engine 804 extracts segments from a raster image having modified (e.g., blended) pixels. For example, in some cases, the segmentation engine 804 uses a segmentation model to extract a plurality of segments from a raster image.

As further shown in FIG. 8, the opacity-aware vectorization system 106 includes a map generator 806. In one or more embodiments, the map generator 806 generates one or more maps that associated pixel related information to segments extracted from a raster image. For instance, in some cases, the map generator 806 generates a segment-to-pixel mapping that maps extracted segments to the pixels that are included in those segments. Additionally, in some instances, the map generator 806 generates opacity maps that map opacity values represented in a segment to the number of pixels of the segment having those opacity values. Further, in some embodiments, the map generator 806 generates color maps that maps color values represented in a segment to the number of pixels of the segment having those color values. The map generator 806 generates the opacity maps and the color maps as part of the segment-to-pixel mapping or as separate maps in various embodiments. In some instances, the map generator 806 also determines vector opacity values and vector color values corresponding to the mapped opacity values and color values for use in the final vector graphic and stores those values in the segment-to-pixel mapping.

As shown in FIG. 8, the opacity-aware vectorization system 106 also includes the vectorization engine 808. In one or more embodiments, the vectorization engine 808 generates a vector graphic from a raster image. For instance, in some cases, the vectorization engine 808 generates one or more vector paths for each segment extracted from the raster image. Further, in some cases, the vectorization engine 808 applies, to each vector path, a vector opacity value and a vector color value determined from the opacity values and color values of the corresponding segment. In some cases, the vectorization engine 808 retrieves the vector opacity value and vector color value from a segment-to-pixel mapping generated from the raster image.

Further, as shown in FIG. 8, the opacity-aware vectorization system 106 includes data storage 810. In particular, data storage 810 includes segmentation model 812 and raster image 814. In one or more embodiments, segmentation model 812 includes the segmentation model used to extract a plurality of segments from raster images. In some embodiments, raster image 814 includes the raster image to be vectorized.

Each of the components 802-814 of the opacity-aware vectorization system 106 optionally include software, hardware, or both. For example, in some cases, the components 802-814 include one or more instructions stored on a computer-readable storage medium and executable by processors of one or more computing devices, such as a client device or server device. When executed by the one or more processors, the computer-executable instructions of one or more embodiments of the opacity-aware vectorization system 106 cause the computing device(s) to perform the methods described herein. Alternatively, in some instances, the components 802-814 include hardware, such as a special-purpose processing device to perform a certain function or group of functions. Alternatively, in certain implementations, the components 802-814 of the opacity-aware vectorization system 106 include a combination of computer-executable instructions and hardware.

Furthermore, in one or more embodiments, the components 802-814 of the opacity-aware vectorization system 106 are, for example, implemented as one or more operating systems, as one or more stand-alone applications, as one or more modules of an application, as one or more plug-ins, as one or more library functions or functions that are called by other applications, and/or as a cloud-computing model. Thus, in some embodiments, the components 802-814 of the opacity-aware vectorization system 106 are implemented as a stand-alone application, such as a desktop or mobile application. Furthermore, in some cases, the components 802-814 of the opacity-aware vectorization system 106 are implemented as one or more web-based applications hosted on a remote server. Alternatively, or additionally, the components 802-814 of the opacity-aware vectorization system 106 are implemented in a suite of mobile device applications or “apps.” For example, in one or more embodiments, the opacity-aware vectorization system 106 comprises or operates in connection with digital software applications such as ADOBE® PHOTOSHOP®, ADOBE® ILLUSTRATOR®, or ADOBE® FIREFLY®. The foregoing are either registered trademarks or trademarks of Adobe Inc. in the United States and/or other countries.

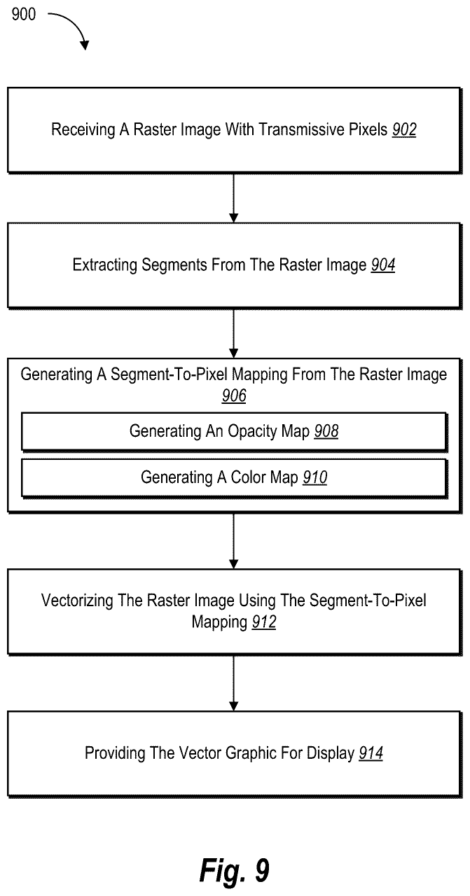

FIGS. 1-8, the corresponding text, and the examples provide a number of different methods, systems, devices, and non-transitory computer-readable media of the opacity-aware vectorization system 106. In addition to the foregoing, one or more embodiments are also described in terms of flowcharts comprising acts for accomplishing the particular result, as shown in FIG. 9. In one or more embodiments, FIG. 9 is performed with more or fewer acts. Further, in some embodiments, the acts are performed in different orders. Additionally, in some cases, the acts described herein are repeated or performed in parallel with one another or in parallel with different instances of the same or similar acts.

FIG. 9 illustrates a flowchart of a series of acts 900 for vectorizing a raster image while translating a transmissive property portrayed therein in accordance with one or more embodiments. FIG. 9 illustrates acts according to one embodiment, but alternative embodiments omit, add to, reorder, and/or modify any of the acts shown in FIG. 9. In some implementations, the acts of FIG. 9 are performed as part of a computer-implemented method. Alternatively, in some embodiments, a non-transitory computer-readable medium stores executable instructions thereon that, when executed by a processing device, cause the processing device to perform operations comprising the acts of FIG. 9. In some embodiments, a system performs the acts of FIG. 9. For example, in some cases, a system includes one or more memory devices. The system further includes one or more processors configured to cause the system to perform the acts of FIG. 9.

The series of acts 900 includes an act 902 for receiving a raster image with transmissive pixels. For example, in one or more embodiments, the act 902 involves receiving, from a client device, a raster image that includes a set of pixels having a transmissive property.

In some embodiments, receiving the raster image that includes the set of pixels having the transmissive property comprises receiving the raster image that includes a set of translucent pixels. In some cases, the opacity-aware vectorization system 106 further modifies the set of translucent pixels to remove a translucency of the set of translucent pixels before extracting the plurality of segments by blending a base color value of the set of translucent pixels with an additional color value. In some implementations, receiving the raster image that includes the set of translucent pixels comprises receiving the raster image that includes the set of translucent pixels having the base color value blended with a background color value. As such, in some cases, blending the base color value of the set of translucent pixels with the additional color value comprises replacing the background color value with the additional color value for the set of translucent pixels.

In certain implementations, receiving the raster image that includes the set of pixels having the transmissive property comprises receiving the raster image that includes a set of transparent pixels. In some cases, the opacity-aware vectorization system 106 further modifies the set of transparent pixels to remove a transparency of the set of transparent pixels before extracting the plurality of segments by blending the set of transparent pixels with a color value.

The series of acts 900 also includes an act 904 for extracting segments from the raster image. For instance, in some embodiments, the act 904 involves extracting, using a segmentation model, a plurality of segments from the raster image.

Additionally, the series of acts 900 includes an act 906 for generating a segment-to-pixel mapping from the raster image. To illustrate, in some cases, the act 906 involves generating, from the raster image, a segment-to-pixel mapping that maps a segment from the plurality of segments to the set of pixels having the transmissive property.

As shown in FIG. 9, in certain cases, the act 906 includes a sub-act 908 of generating an opacity map. Further, as shown, in some implementations, the act 906 includes a sub-act 910 generating a color map. In some cases, the opacity-aware vectorization system 106 generates a plurality of opacity maps and/or a plurality of color maps.

To illustrate, in one or more embodiments, the opacity-aware vectorization system 106 generates an opacity map that associates the segment mapped to the set of pixels within the segment-to-pixel mapping with one or more opacity values. Additionally, in some embodiments, the opacity-aware vectorization system 106 generates a color map that associates the segment mapped to the set of pixels within the segment-to-pixel mapping with one or more color values.

Further, the series of acts 900 includes an act 912 for vectorizing the raster image using the segment-to-pixel mapping. For instance, in one or more embodiments, the act 912 involves vectorizing the raster image by generating, using the segment-to-pixel mapping, a vector graphic having a vector path that corresponds to the segment and includes the transmissive property.

In one or more embodiments, generating, using the segment-to-pixel mapping, the vector graphic having the vector path that corresponds to the segment and includes the transmissive property comprises generating, using the opacity map, the vector graphic having the vector path that corresponds to the segment and includes a vector opacity value based on the one or more opacity values. In some embodiments, the opacity-aware vectorization system 106 determines the vector opacity value for the vector path by determining a weighted average of the one or more opacity values. Additionally, in some cases, generating, using the segment-to-pixel mapping, the vector graphic having the vector path that corresponds to the segment comprises generating, using the color map, the vector graphic having the vector path that corresponds to the segment and includes a vector color value based on the one or more color values. In some instances, the opacity-aware vectorization system 106 determines the vector color value for the vector path based on a number of pixels from the set of pixels associated with each color value from the one or more color values.

In some implementations, receiving the raster image that includes the set of pixels having the transmissive property comprises receiving the raster image that includes the set of pixels having the transmissive property portrayed in a radial gradient; and generating the vector graphic having the vector path that corresponds to the segment and includes the transmissive property comprises generating the vector graphic having a plurality of vector paths that portray the transmissive property in the radial gradient.

The series of acts 900 also includes an act 914 of providing the vector graphic for display. For instance, in some cases, the opacity-aware vectorization system 106 provides the vector graphic for display within a graphical user interface of the client device from which the raster image was received.

To provide an illustration, in one or more embodiments, the opacity-aware vectorization system 106 modifies a set of pixels within a raster image by blending the set of pixels with a color value; extracts, from the raster image and using a segmentation model, a plurality of segments that includes a segment corresponding to the modified set of pixels; generates, for the segment, an opacity map that associates one or more opacity values with the segment; generates, for the segment, a color map that associates one or more color values with the segment; and vectorizes the raster image by generating a vector graphic having a vector path that corresponds to the segment, the vector path having a vector opacity value based on the opacity map and a vector color value based on the color map.

In one or more embodiments, the opacity-aware vectorization system 106 generates, for the segment, the opacity map that associates the one or more opacity values with the segment by, within the opacity map: mapping a first opacity value from the one or more opacity values to a first number of pixels from the set of pixels that includes the first opacity value within the raster image; and mapping a second opacity value from the one or more opacity values to a second number of pixels from the set of pixels that includes the second opacity value within the raster image. In some cases, generating the vector graphic having the vector path with the vector opacity value based on the opacity map comprises: determining a weighted average of the one or more opacity values using the first number of pixels as a first weighting for the first opacity value and using the second number of pixels as a second weighting for the second opacity value; and generating the vector path to include the vector opacity value corresponding to the weighted average of the one or more opacity values.

In one or more embodiments, the opacity-aware vectorization system 106 generates, for the segment, the color map that associates the one or more color values with the segment by, within the color map: mapping a first color value from the one or more color values to a first number of pixels from the set of pixels that includes the first color value within the raster image; and mapping a second color value from the one or more color values to a second number of pixels from the set of pixels that includes the second color value within the raster image. In some cases, generating the vector graphic having the vector path with the vector color value based on the color map comprises: extracting a representative color value from the first color value and the second color value by determining whether the first number of pixels or the second number of pixels is greater; and generating the vector path to include the vector color value corresponding to the representative color value.

In one or more embodiments, the opacity-aware vectorization system 106 modifies the vector graphic by at least one of: modifying vector opacity values of a plurality of vector paths of the vector graphic using an opacity smoothing model; or modifying vector color values of the plurality of vector paths using a color equalizer model.

To provide another illustration, in one or more embodiments, the opacity-aware vectorization system 106 receives a raster image that includes a set of translucent pixels; modifies the set of translucent pixels within the raster image by blending a base color value of the set of translucent pixels with an additional color value; extracts, from the raster image and using a segmentation model, a segment that corresponds to the modified set of translucent pixels; and vectorizes the raster image by generating a vector graphic having a vector path that corresponds to the segment and includes a vector opacity value based on one or more opacity values associated with the set of translucent pixels.

In some embodiments, blending the base color value of the set of translucent pixels with the additional color value includes blending the base color value of the set of translucent pixels with a white color value. In some cases, modifying the set of translucent pixels within the raster image by blending the base color value of the set of translucent pixels with the additional color value comprises: blending the base color value of a first subset of translucent pixels from the set of translucent pixels with the additional color value based on determining that an opacity value of the first subset of translucent pixels satisfies an opacity threshold; and blending a second subset of translucent pixels from the set of translucent pixels with a further color value based on determining that an additional opacity value of the second subset of translucent pixels fails to satisfy the opacity threshold.

In some instances, the opacity-aware vectorization system 106 determines a distant color value that differs from all color values portrayed in the raster image; and modifies a set of transparent pixels of the raster image by blending the set of transparent pixels with the distant color value. In some cases, determining the distant color value comprises determining the distant color value using one of a random color generation model, a color space sampling model, or a convex hull algorithm.

Some embodiments of the present disclosure comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, in some cases, one or more of the processes described herein are implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory), and executes those instructions, thereby performing one or more processes, including one or more of the processes described herein.

In one or more embodiments, computer-readable media include various available media that is accessible by a general purpose or special purpose computer system. Computer-readable media that store computer-executable instructions are non-transitory computer-readable storage media (devices). Computer-readable media that carry computer-executable instructions are transmission media. Thus, by way of example, and not limitation, one or more embodiments of the disclosure comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which is usable to store desired program code means in the form of computer-executable instructions or data structures and which is accessible by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. In some cases, transmissions media includes a network and/or data links which are usable to carry desired program code means in the form of computer-executable instructions or data structures and which is accessible by a general purpose or special purpose computer. Combinations of the above should also be included within the scope of computer-readable media.

Further, upon reaching various computer system components, program code means in the form of computer-executable instructions or data structures is transferrable automatically from transmission media to non-transitory computer-readable storage media (devices) (or vice versa). For example, in some cases, computer-executable instructions or data structures received over a network or data link are buffered in RAM within a network interface module (e.g., a “NIC”), and then eventually transferred to computer system RAM and/or to less volatile computer storage media (devices) at a computer system. Thus, it should be understood that, in some cases, non-transitory computer-readable storage media (devices) are included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. In some instances, the computer executable instructions are, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that one or more embodiments are practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. Some implementations are practiced in distributed system environments where local and remote computer systems, which are linked (either by hardwired data links, wireless data links, or by a combination of hardwired and wireless data links) through a network, both perform tasks. In some implementations, in a distributed system environment, program modules are located in both local and remote memory storage devices.

Some embodiments of the present disclosure are implemented in cloud computing environments. In this description, “cloud computing” is defined as a model for enabling on-demand network access to a shared pool of configurable computing resources. For example, in some cases, cloud computing is employed in the marketplace to offer ubiquitous and convenient on-demand access to the shared pool of configurable computing resources. In some instances, the shared pool of configurable computing resources is rapidly provisioned via virtualization and released with low management effort or service provider interaction, and then scaled accordingly.

In one or more embodiments, a cloud-computing model is composed of various characteristics such as, for example, on-demand self-service, broad network access, resource pooling, rapid elasticity, measured service, and so forth. In some embodiments, a cloud-computing model exposes various service models, such as, for example, Software as a Service (“SaaS”), Platform as a Service (“PaaS”), and Infrastructure as a Service (“IaaS”). In some instances, a cloud-computing model is deployed using different deployment models such as private cloud, community cloud, public cloud, hybrid cloud, and so forth. In this description and in the claims, a “cloud-computing environment” is an environment in which cloud computing is employed.

FIG. 10 illustrates a block diagram of an example computing device 1000 that is configured to perform one or more of the processes described above in some embodiments. One will appreciate that one or more computing devices, such as the computing device 1000, represent the computing devices described above (e.g., the server device(s) 102 and/or the client devices 110a-110n) in some implementations. In one or more embodiments, the computing device 1000 is a mobile device (e.g., a mobile telephone, a smartphone, a PDA, a tablet, a laptop, a camera, a tracker, a watch, a wearable device). In some embodiments, the computing device 1000 is a non-mobile device (e.g., a desktop computer or another type of client device). Further, in certain embodiments, the computing device 1000 is a server device that includes cloud-based processing and storage capabilities.

As shown in FIG. 10, the computing device 1000 includes one or more processor(s) 1002, memory 1004, a storage device 1006, input/output interfaces 1008 (or “I/O interfaces 1008”), and a communication interface 1010, which are communicatively coupled by way of a communication infrastructure (e.g., bus 1012). While the computing device 1000 is shown in FIG. 10, the components illustrated in FIG. 10 are not intended to be limiting. Additional or alternative components are used in other embodiments. Furthermore, in certain embodiments, the computing device 1000 includes fewer components than those shown in FIG. 10. Components of the computing device 1000 shown in FIG. 10 will now be described in additional detail.

In particular embodiments, the processor(s) 1002 includes hardware for executing instructions, such as those making up a computer program. As an example, and not by way of limitation, to execute instructions, the processor(s) 1002 retrieve (or fetch) the instructions from an internal register, an internal cache, memory 1004, or a storage device 1006 and decode and execute them in some implementations.

The computing device 1000 includes memory 1004, which is coupled to the processor(s) 1002. In certain cases, the memory 1004 is used for storing data, metadata, and programs for execution by the processor(s). In some instances, the memory 1004 includes one or more of volatile and non-volatile memories, such as Random-Access Memory (“RAM”), Read-Only Memory (“ROM”), a solid-state disk (“SSD”), Flash, Phase Change Memory (“PCM”), or other types of data storage. In some embodiments, the memory 1004 includes internal or distributed memory.

The computing device 1000 includes a storage device 1006 including storage for storing data or instructions. As an example, and not by way of limitation, in some cases, the storage device 1006 includes a non-transitory storage medium described above. In some embodiments, the storage device 1006 includes a hard disk drive (HDD), flash memory, a Universal Serial Bus (USB) drive or a combination these or other storage devices.

As shown, the computing device 1000 includes one or more I/O interfaces 1008, which are provided to allow a user to provide input to (such as user strokes), receive output from, and otherwise transfer data to and from the computing device 1000. In one or more embodiments, these I/O interfaces 1008 include a mouse, keypad or a keyboard, a touch screen, camera, optical scanner, network interface, modem, other known I/O devices or a combination of such I/O interfaces 1008. In some cases, the touch screen is activated with a stylus or a finger.

In one or more embodiments, the I/O interfaces 1008 include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1008 are configured to provide graphical data to a display for presentation to a user. In some cases, the graphical data is representative of one or more graphical user interfaces and/or any other graphical content that serves a particular implementation.

The computing device 1000 further includes a communication interface 1010. In some cases, the communication interface 1010 includes hardware, software, or both. The communication interface 1010 provides one or more interfaces for communication (such as, for example, packet-based communication) between the computing device and one or more other computing devices or one or more networks. As an example, and not by way of limitation, in some cases, communication interface 1010 includes a network interface controller (NIC) or network adapter for communicating with an Ethernet or other wire-based network or a wireless NIC (WNIC) or wireless adapter for communicating with a wireless network, such as a WI-FI. The computing device 1000 further includes a bus 1012. In some cases, the bus 1012 includes hardware, software, or both that connects components of computing device 1000 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

Various implementations of the present invention are embodied in other specific forms without departing from its spirit or essential characteristics. The described embodiments are to be considered in all respects only as illustrative and not restrictive. For example, in some embodiments, the methods described herein are performed with less or more steps/acts or the steps/acts are performed in differing orders. Additionally, in some cases, the steps/acts described herein are repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
receiving, from a client device, a raster image that includes a set of pixels having a transmissive property;
extracting, using a segmentation model, a plurality of segments from the raster image;
generating, from the raster image, a segment-to-pixel mapping that maps a segment from the plurality of segments to the set of pixels having the transmissive property;
vectorizing the raster image by generating, using the segment-to-pixel mapping, a vector graphic having a vector path that corresponds to the segment and includes the transmissive property; and
providing, for display on the client device, the vector graphic.

2. The computer-implemented method of claim 1,
wherein receiving the raster image that includes the set of pixels having the transmissive property comprises receiving the raster image that includes a set of translucent pixels; and
further comprising modifying the set of translucent pixels to remove a translucency of the set of translucent pixels before extracting the plurality of segments by blending a base color value of the set of translucent pixels with an additional color value.

3. The computer-implemented method of claim 2, wherein:
receiving the raster image that includes the set of translucent pixels comprises receiving the raster image that includes the set of translucent pixels having the base color value blended with a background color value; and
blending the base color value of the set of translucent pixels with the additional color value comprises replacing the background color value with the additional color value for the set of translucent pixels.

4. The computer-implemented method of claim 1,
wherein receiving the raster image that includes the set of pixels having the transmissive property comprises receiving the raster image that includes a set of transparent pixels; and
further comprising modifying the set of transparent pixels to remove a transparency of the set of transparent pixels before extracting the plurality of segments by blending the set of transparent pixels with a color value.

5. The computer-implemented method of claim 1,
further comprising generating an opacity map that associates the segment mapped to the set of pixels within the segment-to-pixel mapping with one or more opacity values,
wherein generating, using the segment-to-pixel mapping, the vector graphic having the vector path that corresponds to the segment and includes the transmissive property comprises generating, using the opacity map, the vector graphic having the vector path that corresponds to the segment and includes a vector opacity value based on the one or more opacity values.

6. The computer-implemented method of claim 5, further comprising determining the vector opacity value for the vector path by determining a weighted average of the one or more opacity values.

7. The computer-implemented method of claim 1,
further comprising generating a color map that associates the segment mapped to the set of pixels within the segment-to-pixel mapping with one or more color values,
wherein generating, using the segment-to-pixel mapping, the vector graphic having the vector path that corresponds to the segment comprises generating, using the color map, the vector graphic having the vector path that corresponds to the segment and includes a vector color value based on the one or more color values.

8. The computer-implemented method of claim 7, further comprising determining the vector color value for the vector path based on a number of pixels from the set of pixels associated with each color value from the one or more color values.

9. The computer-implemented method of claim 1, wherein:
receiving the raster image that includes the set of pixels having the transmissive property comprises receiving the raster image that includes the set of pixels having the transmissive property portrayed in a radial gradient; and
generating the vector graphic having the vector path that corresponds to the segment and includes the transmissive property comprises generating the vector graphic having a plurality of vector paths that portray the transmissive property in the radial gradient.

10. A system comprising:
one or more memory devices; and
one or more processors configured to cause the system to:
modify a set of pixels within a raster image by blending the set of pixels with a color value;
extract, from the raster image and using a segmentation model, a plurality of segments that includes a segment corresponding to the modified set of pixels;
generate, for the segment, an opacity map that associates one or more opacity values with the segment;
generate, for the segment, a color map that associates one or more color values with the segment; and
vectorize the raster image by generating a vector graphic having a vector path that corresponds to the segment, the vector path having a vector opacity value based on the opacity map and a vector color value based on the color map.

11. The system of claim 10, wherein the one or more processors are configured to cause the system to generate, for the segment, the opacity map that associates the one or more opacity values with the segment by, within the opacity map:
mapping a first opacity value from the one or more opacity values to a first number of pixels from the set of pixels that includes the first opacity value within the raster image; and
mapping a second opacity value from the one or more opacity values to a second number of pixels from the set of pixels that includes the second opacity value within the raster image.

12. The system of claim 11, wherein generating the vector graphic having the vector path with the vector opacity value based on the opacity map comprises:
determining a weighted average of the one or more opacity values using the first number of pixels as a first weighting for the first opacity value and using the second number of pixels as a second weighting for the second opacity value; and
generating the vector path to include the vector opacity value corresponding to the weighted average of the one or more opacity values.

13. The system of claim 10, wherein the one or more processors are configured to cause the system to generate, for the segment, the color map that associates the one or more color values with the segment by, within the color map:
mapping a first color value from the one or more color values to a first number of pixels from the set of pixels that includes the first color value within the raster image; and
mapping a second color value from the one or more color values to a second number of pixels from the set of pixels that includes the second color value within the raster image.

14. The system of claim 13, wherein generating the vector graphic having the vector path with the vector color value based on the color map comprises:
extracting a representative color value from the first color value and the second color value by determining whether the first number of pixels or the second number of pixels is greater; and
generating the vector path to include the vector color value corresponding to the representative color value.

15. The system of claim 10, wherein the one or more processors are further configured to cause the system to modify the vector graphic by at least one of:
modifying vector opacity values of a plurality of vector paths of the vector graphic using an opacity smoothing model; or
modifying vector color values of the plurality of vector paths using a color equalizer model.

16. A non-transitory computer-readable medium storing executable instructions which, when executed by a processing device, cause the processing device to perform operations comprising:
receiving a raster image that includes a set of translucent pixels;
modifying the set of translucent pixels within the raster image by blending a base color value of the set of translucent pixels with an additional color value;
extracting, from the raster image and using a segmentation model, a segment that corresponds to the modified set of translucent pixels; and
vectorizing the raster image by generating a vector graphic having a vector path that corresponds to the segment and includes a vector opacity value based on one or more opacity values associated with the set of translucent pixels.

17. The non-transitory computer-readable medium of claim 16, wherein blending the base color value of the set of translucent pixels with the additional color value includes blending the base color value of the set of translucent pixels with a white color value.

18. The non-transitory computer-readable medium of claim 16, wherein the operations further comprise:
determining a distant color value that differs from all color values portrayed in the raster image; and
modifying a set of transparent pixels of the raster image by blending the set of transparent pixels with the distant color value.

19. The non-transitory computer-readable medium of claim 18, wherein determining the distant color value comprises determining the distant color value using one of a random color generation model, a color space sampling model, or a convex hull algorithm.

20. The non-transitory computer-readable medium of claim 16, modifying the set of translucent pixels within the raster image by blending the base color value of the set of translucent pixels with the additional color value comprises:
blending the base color value of a first subset of translucent pixels from the set of translucent pixels with the additional color value based on determining that an opacity value of the first subset of translucent pixels satisfies an opacity threshold; and
blending a second subset of translucent pixels from the set of translucent pixels with a further color value based on determining that an additional opacity value of the second subset of translucent pixels fails to satisfy the opacity threshold.
